(19) United States
(12) Patent Application Publication
(10) Pub. No.: US 2012/0320041 A1
(43) Pub. Date: Dec. 20, 2012

(54) Stereoscopic Display Apparatus and Stereoscopic Display Method

(75) Inventor: Teruto Tanaka, Osaka (JP)

(73) Assignee: PANASONIC CORPORATION, Osaka (JP)

(21) Appl. No.: 13/517,610

(22) Filed: Jun. 14, 2012

(30) Foreign Application Priority Data
Jun. 15, 2011 (JP) 2011-133347

(51) Int. Cl. G06T 15/00

(52) U.S. Cl. 345/419

(57) ABSTRACT

A first image separation section separates an image signal of a slave screen into right eye and left eye slave screen images. A second image separation section separates an image signal of a master screen into right eye and left eye master screen images. A first image position adjustment section adjusts a display position of the right eye slave screen image such that the right eye slave screen image shifts left by a predetermined amount and adjusts a display position of the left eye slave screen image such that the left eye slave screen image shifts right by a predetermined amount. First and second image combination sections combine the right eye slave screen image and the right eye master screen image to generate a right eye image and combine the left eye slave screen image and the left eye master screen image to generate a left eye image.

### BACKGROUND

1. Field

The present disclosure relates to a stereoscopic display apparatus, and more particularly relates to a video display apparatus and a video display method that realize a stereoscopic video display by using two two-dimensional (2D) contents.

2. Description of the Related Art

In a video display apparatus capable of performing a stereoscopic video display, such as a projector or a flat display, in the case of conducting a presentation in three-dimensional (3D) display, it is necessary to prepare a three-dimensional content. However, it takes time to create the three-dimensional content. Thus, in order to reduce the creating time, various techniques for converting a two-dimensional content into a three-dimensional content have been proposed. For example, please see the specifications of Japanese Laid-Open Patent Publication No. H11-110180 and Japanese Patent No. 4482657.

Even in the conventional techniques described above, however, an unnatural three-dimensional display occurs due to erroneous content conversion, and the cost of the video display apparatus increases if a content conversion function is prioritized.

### SUMMARY

Therefore, the present disclosure provides a stereoscopic display apparatus and stereoscopic display method that allow one of two two-dimensional contents to easily be displayed stereoscopically by using the two two-dimensional contents without increasing the cost of the video display apparatus.

The present disclosure is directed to a stereoscopic display apparatus capable of superimposing and displaying two images. The stereoscopic display apparatus includes: a first image separation section configured to receive an image signal of a slave screen and to separate the image signal of the slave screen into a right eye slave screen image and a left eye slave screen image; a second image separation section configured to receive an image signal of a master screen and to separate the image signal of the master screen into a right eye master screen image and a left eye master screen image; a first image position adjustment section configured to adjust a display position of the right eye slave screen image such that the right eye slave screen image shifts left by a predetermined amount and to adjust a display position of the left eye slave screen image such that the left eye slave screen image shifts right by a predetermined amount; an image combination section configured to combine the right eye slave screen image that has been adjusted and the right eye master screen image to generate a right eye image and to combine the left eye slave screen image that has been adjusted and the left eye master screen image to generate a left eye image; and a display section configured to display stereoscopic video by using the right eye image and the left eye image.

Moreover, the stereoscopic display apparatus may further include a second image position adjustment section configured to adjust a display position of the right eye master screen image such that the right eye master screen image shifts right by a predetermined amount and to adjust a display position of the left eye master screen image such that the left eye master screen image shifts left by a predetermined amount, and the image combination section may combine the right eye slave screen image that has been adjusted and the right eye master screen image that has been adjusted, to generate a right eye image, and may combine the left eye slave screen image that has been adjusted and the left eye master screen image that has been adjusted, to generate a left eye image.

The stereoscopic display apparatus may further include an image processing section configured to correct an image contour of the slave screen to be sharp and to correct an image contour of the master screen to be soft, or an image processing section configured to increase an image brightness of the slave screen and to decrease an image brightness of the master screen. In addition, the stereoscopic display apparatus may further include an image size adjustment section configured to enlarge or reduce an image size of the slave screen.

It should be noted that the present disclosure can be implemented in various forms other than the stereoscopic display apparatus. For example, the present disclosure can be implemented in forms such as a stereoscopic display method, an integrated circuit for implementing the functions of the stereoscopic display apparatus, a computer program for executing the stereoscopic display method, and a storage medium having the computer program stored therein.

According to the stereoscopic display apparatus and the stereoscopic display method of the present disclosure, one of two two-dimensional contents can easily be displayed stereoscopically by using the two two-dimensional contents.

These and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing the configuration of a stereoscopic display apparatus 1 according to an embodiment of the present disclosure;

FIG. 2 is a diagram conceptually illustrating a stereoscopic view effect obtained by the stereoscopic display apparatus 1; and

FIG. 3 is a diagram illustrating an image position adjustment method performed by first and second image position adjustment sections 21 and 22.

### DETAILED DESCRIPTION

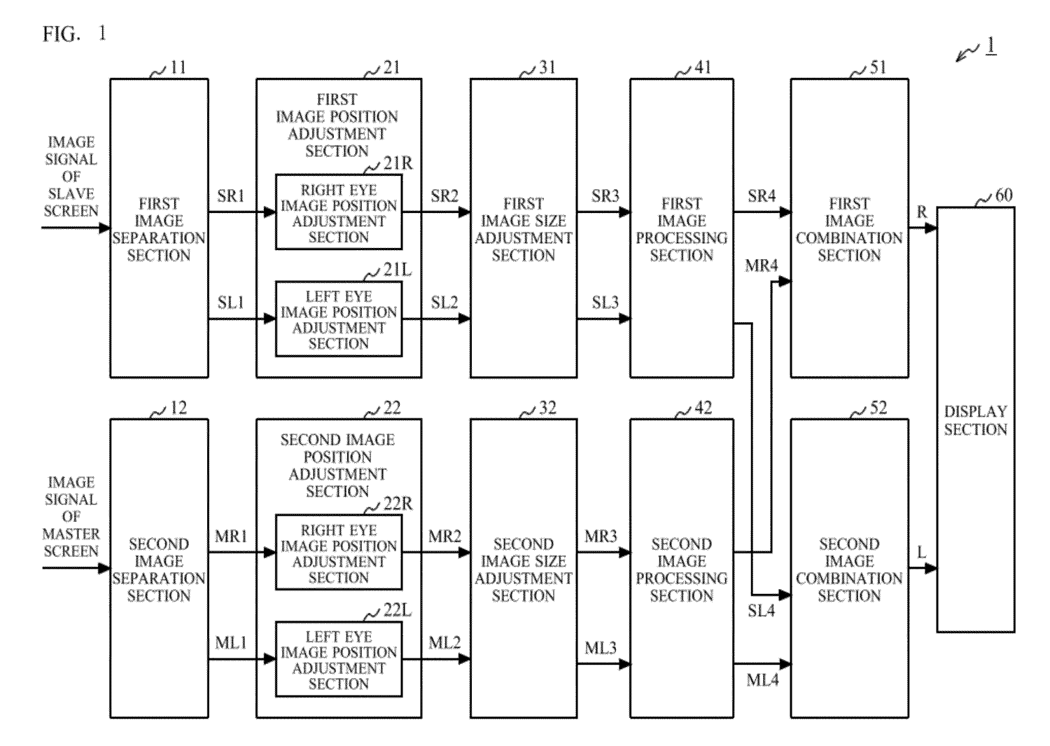

FIG. 1 is a diagram showing the configuration of a stereoscopic display apparatus 1 according to an embodiment of the present disclosure. The stereoscopic display apparatus 1 according to the present embodiment shown in FIG. 1 is an apparatus that can display three-dimensional video by utilizing three-dimensional recognition by means of parallax between the eyes, and includes first and second image separation sections 11 and 12, first and second image position adjustment sections 21 and 22, an image size adjustment section including first and second image size adjustment sections 31 and 32, an image processing section including first and second image processing sections 41 and 42, an image combination section including first and second image combination sections 51 and 52, and a display section 60.

First, an outline of each configuration of the stereoscopic display apparatus 1 according to the present embodiment will be described.

The first image separation section 11 receives, from an external apparatus (e.g., a personal computer), an image signal of a first two-dimensional content that is caused to be stereoscopically viewed on a display screen to draw attention. In the present embodiment, a description is given with, as an example, a case of performing a screen display called picture-in-picture. In this case, the first two-dimensional content corresponds to a “slave screen”. The first image separation section 11 separates the received image signal of the slave screen into a right eye slave screen image SR1 and a left eye slave screen image SL1.

The second image separation section 12 receives, from an external apparatus (e.g., a personal computer), an image signal of a second two-dimensional content that is not caused to be stereoscopically viewed on the display screen such that attention is not drawn thereto. In the picture-in-picture screen display exemplified in the present embodiment, the second two-dimensional content corresponds to a “master screen”. The second image separation section 12 separates the received image signal of the master screen into a right eye master screen image MR1 and a left eye master screen image ML1.

It should be noted that the external apparatus that inputs the image signal of the slave screen into the first image separation section 11 may be the same as or different from the external apparatus that inputs the image signal of the master screen into the second image separation section 12. In addition, an image signal that is previously retained by the stereoscopic display apparatus 1 may be used as the image signal of the master screen.

The first image position adjustment section 21 includes a right eye image position adjustment section 21R and a left eye image position adjustment section 21L. In addition, the second image position adjustment section 22 includes a right eye image position adjustment section 22R and a left eye image position adjustment section 22L.

The right eye image position adjustment section 21R adjusts an image display position of the right eye slave screen image SR1, which is obtained by the separation by the first image separation section 11, when being displayed on the screen.

The left eye image position adjustment section 21L adjusts an image display position of the left eye slave screen image SL1, which is obtained by the separation by the first image separation section 11, when being displayed on the screen.

The right eye image position adjustment section 22R adjusts an image display position of the right eye master screen image MR1, which is obtained by the separation by the second image separation section 12, when being displayed on the screen.

The left eye image position adjustment section 22L adjusts an image display position of the left eye master screen image ML1, which is obtained by the separation by the second image separation section 12, when being displayed on the screen.

The position adjustment processing performed by each image position adjustment section will be described later.

The first image size adjustment section 31 enlarges or downscales a right eye slave screen image SR2 obtained by the position adjustment by the right eye image position adjustment section 21R and a left eye slave screen image SL2 obtained by the position adjustment by the left eye image position adjustment section 21L, to adjust the image sizes of the right eye slave screen image SR2 and the left eye slave screen image SL2.

The second image size adjustment section 32 enlarges or downscales a right eye master screen image MR2 obtained by the position adjustment by the right eye image position adjustment section 22R and a left eye master screen image ML2 obtained by the position adjustment by the left eye image position adjustment section 22L, to adjust the image sizes of the right eye master screen image MR2 and the left eye master screen image ML2.

The size adjustment processing performed by each image size adjustment section will be described later.

The first image processing section 41 performs predetermined image processing on a right eye slave screen image SR3 and a left eye slave screen image SL3 that are obtained by the size adjustment by the first image size adjustment section 31.

The second image processing section 42 performs predetermined image processing on a right eye master screen image MR3 and a left eye master screen image ML3 that are obtained by the size adjustment by the second image size adjustment section 32.

The image processing performed by each image processing section will be described later.

The first image combination section 51 combines a right eye slave screen image SR4 obtained by the image processing by the first image processing section 41 and the right eye master screen image MR4 obtained by the image processing by the second image processing section 42, to generate a right eye image R in which the right eye slave screen image SR4 is superimposed on the right eye master screen image MR4.

The second image combination section 52 combines a left eye slave screen image SL4 obtained by the image processing by the first image processing section 41 and a left eye master screen image ML4 obtained by the image processing by the second image processing section 42, to generate a left eye image L in which the left eye slave screen image SL4 is superimposed on the left eye master screen image ML4.

It should be noted that control of whether to combine the slave screen with the master screen in the first and second image combination sections 51 and 52 may be switched by a control section (not shown) included in the stereoscopic display apparatus 1. An instruction to the control section can be performed by operating a button (not shown) provided in a body of the stereoscopic display apparatus 1, a remote controller, or the like.

The display section 60 receives the right eye image R generated by the first image combination section 51 and the left eye image L generated by the second image combination section 52. The display section 60 displays stereoscopic video by alternately frame-displaying the right eye image R and the left eye image L at a timing synchronized with shutter switching of a 3D visor (not shown).

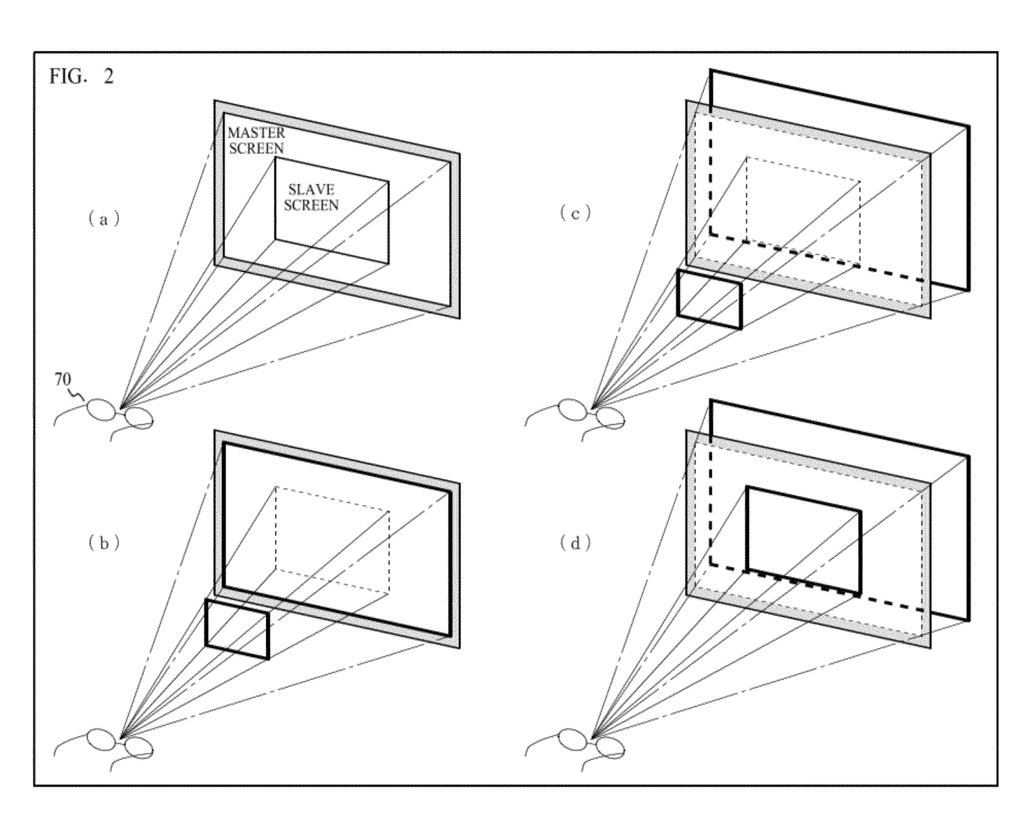

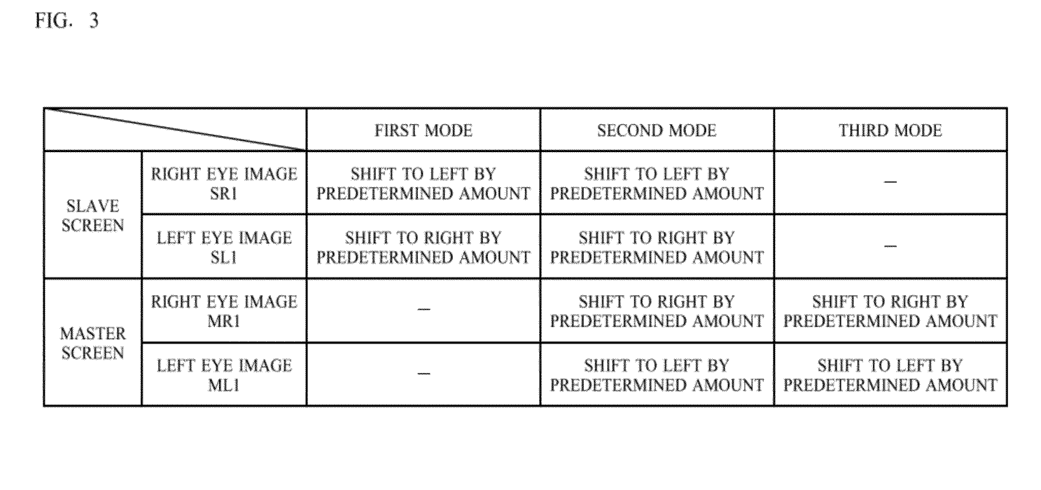

Next, image position adjustment processing performed by the stereoscopic display apparatus 1 of the present embodiment will be described with reference to FIGS. 2 and 3. FIG. 2 is a diagram conceptually illustrating a stereoscopic view effect obtained by the stereoscopic display apparatus 1 and using a 3D visor 70. FIG. 3 is a diagram illustrating an image position adjustment method (a first mode, a second mode, and a third mode) performed by the first and second image position adjustment sections 21 and 22.

<First Mode>

In a position adjustment method by the first mode, only position adjustment of the slave screen image (SR1 and SL1) by the first image position adjustment section 21 is performed, and position adjustment of the master screen image (MR1 and ML1) by the second image position adjustment section 22 is not performed. Please see the first mode shown in FIG. 3.

Specifically, the right eye image position adjustment section 21R of the first image position adjustment section 21 adjusts the display position of the right eye slave screen image SR1 such that the right eye slave screen image SR1 shifts from the original display position in the leftward direction of the screen by a predetermined amount XR when the slave screen is displayed on the display section 60. In addition, the left eye image position adjustment section 21L of the first image position adjustment section 21 adjusts the display position of the left eye slave screen image SL1 such that the left eye slave screen image SL1 shifts from the original display position in the rightward direction of the screen by a predetermined amount XL when the slave screen is displayed on the display section 60. It should be noted that the predetermined amount XR and the predetermined amount XL may be the same or different from each other and can be freely set according to a desired stereoscopic view effect.

By moving the position of the right eye slave screen image SR1 to the left and the position of the left eye slave screen image SL1 to the right by the predetermined amounts as described above, an effect occurs that the slave screen can be seen as if projecting toward the near side of the display position of the master screen (toward the viewer) when video is displayed on the display section 60 (an image of (b) of FIG. 2).

<Second Mode>

In a position adjustment method by the second mode, both position adjustment of the slave screen image (SR1 and SL1) by the first image position adjustment section 21 and position adjustment of the master screen image (MR1 and ML1) by the second image position adjustment section 22 are performed. Please see the second mode shown in FIG. 3.

Specifically, the right eye image position adjustment section 21R of the first image position adjustment section 21 adjusts the display position of the right eye slave screen image SR1 such that the right eye slave screen image SR1 shifts from the original display position in the leftward direction of the screen by the predetermined amount XR when the slave screen is displayed on the display section 60. In addition, the left eye image position adjustment section 21L of the first image position adjustment section 21 adjusts the display position of the left eye slave screen image SL1 such that the left eye slave screen image SL1 shifts from the original display position in the rightward direction of the screen by the predetermined amount XL when the slave screen is displayed on the display section 60.

Further, the right eye image position adjustment section 22R of the second image position adjustment section 22 adjusts the display position of the right eye master screen image MR1 such that the right eye master screen image MR1 shifts from the original display position in the rightward direction of the screen by a predetermined amount YR when the master screen is displayed on the display section 60. In addition, the left eye image position adjustment section 22L of the second image position adjustment section 22 adjusts the display position of the left eye master screen image ML1 such that the left eye master screen image ML1 shifts from the original display position in the leftward direction of the screen by a predetermined amount YL when the master screen is displayed on the display section 60. It should be noted that the predetermined amount YR and the predetermined amount YL may be the same or different from each other and can be freely set according to a desired stereoscopic view effect.

By moving the position of the right eye master screen image MR1 to the right and the position of the left eye master screen image ML1 to the left by the predetermined amounts as described above, an effect occurs that the master screen can be seen as if being displayed on the far side (on the side opposite to the viewer) when video is displayed on the display section 60. In addition, by moving the position of the right eye slave screen image SR1 to the left and the position of the left eye slave screen image SL1 to the right by the predetermined amounts, an effect occurs that the slave screen can be seen as if projecting toward the near side of the display position of the master screen (toward the viewer) further than in the first mode when video is displayed on the display section 60 (an image of (c) of FIG. 2).

<Third Mode>

In a position adjustment method by the third mode, position adjustment of the slave screen image (SR1 and SL1) by the first image position adjustment section 21 is not performed and only position adjustment of the master screen (MR1 and ML1) by the second image position adjustment section 22 is performed. Please see the third mode shown in FIG. 3.

Specifically, the right eye image position adjustment section 22R of the second image position adjustment section 22 adjusts the display position of the right eye master screen image MR1 such that the right eye master screen image MR1 shifts from the original display position in the rightward direction of the screen by the predetermined amount YR when the master screen is displayed on the display section 60. In addition, the left eye image position adjustment section 22L of the second image position adjustment section 22 adjusts the display position of the left eye master screen image ML1 such that the left eye master screen image ML1 shifts from the original display position in the leftward direction of the screen by the predetermined amount YL when the master screen is displayed on the display section 60.

By moving the position of the right eye master screen image MR1 to the right and the position of the left eye master screen image ML1 to the left by the predetermined amounts as described above, an effect occurs that the master screen can be seen as if being displayed on the far side (on the side opposite to the viewer) and the slave screen can be seen as if projecting toward the near side of the display position of the master screen (toward the viewer) when video is displayed on the display section 60 (an image of (d) of FIG. 2).

Next, image size adjustment processing performed by the stereoscopic display apparatus 1 according to the present embodiment will be described.

In the stereoscopic display apparatus 1 of the present disclosure, it is a point to perform a display such that the slave screen can be seen as if projecting toward the near side of the master screen as described above, that is, it is a point to produce a relative difference in depth between the display plane of the slave screen and the display plane of the master screen. Thus, if the size of the projecting slave screen exceeds the size of the master screen which is the background, the relative difference is eliminated and thus there is the possibility that the slave screen cannot be seen as if projecting toward the near side.

Therefore, the first and second image size adjustment sections 31 and 32 adjust the image size such that the size of the projecting slave screen does not exceed the size of the master screen which is the background. Specifically, when the size of the slave screen exceeds the size of the master screen as a result of the image position adjustment, the size of the slave screen is reduced by using the first image size adjustment section 31 and/or the size of the master screen is enlarged by using the second image size adjustment section 32.

It should be noted that the sizes of the slave screen and the master screen obtained by the reduction and/or the enlargement can be freely set according to a desired stereoscopic view effect.

Next, image processing performed by the stereoscopic display apparatus 1 according to the present embodiment will be described.

As described above, in the stereoscopic display apparatus 1 of the present disclosure, it is a point to produce a relative difference in depth between the display plane of the slave screen and the display plane of the master screen. In order to further effectively provide the relative difference to the viewer, the first and second image processing sections 41 and 42 perform opposite image processing on the slave screen and the master screen.

Specifically, processing of correcting the image contour of the slave screen to be sharp (performing contour correction to a large extent) by using the first image processing section 41 and correcting the image contour of the master screen to be soft (performing contour correction to a small extent) by using the second image processing section 42, is considered. By this processing, the master screen, which is the background, is blurred and the slave screen clearly appears, and thus an effect can be expected that the viewer's attention is drawn to the slave screen.

In addition, a method of increasing the image brightness of the slave screen by using the first image processing section 41 and decreasing the image brightness of the master screen by using the second image processing section 42 is considered. By this processing, the master screen, which is the background, becomes dark and the slave screen brightly appears, and thus an effect can be expected that the viewer's attention is drawn to the slave screen.

As a matter of course, other than the above method, it is possible to use various parameters regarding image processing.

As described above, according to the stereoscopic display apparatus and the stereoscopic display method according to the embodiment of the present disclosure, one of two two-dimensional contents can easily be displayed stereoscopically by using the two two-dimensional contents. Therefore, the user does not need to prepare a three-dimensional content, and it is possible to easily represent a stereoscopic video display (a presentation screen or the like) from a normal two-dimensional content.

In addition, the functions used in the stereoscopic display apparatus according to the present embodiment are low-cost functions such as a dual-screen function, a screen horizontal position adjustment mechanism, and contour correction, and an expensive circuit for converting a two-dimensional content into a three-dimensional content is unnecessary. Thus, the apparatus cost does not become high.

In the embodiment described above, the case has been described where the present disclosure is applied to a stereoscopic video display realized by a frame alternation method using a 3D visor. However, the present disclosure is also applicable to a stereoscopic video display realized by a method other than this method, such as a polarization method or a naked-eye method.

While the present disclosure has been described in detail, the foregoing description is in all aspects illustrative and not restrictive. It will be understood that numerous other modifications and variations can be devised without departing from the scope of the present disclosure.

What is claimed is:

1. A stereoscopic display apparatus capable of superimposing and displaying two images, the stereoscopic display apparatus comprising:
a first image separation section configured to receive an image signal of a slave screen and to separate the image signal of the slave screen into a right eye slave screen image and a left eye slave screen image;
a second image separation section configured to receive an image signal of a master screen and to separate the image signal of the master screen into a right eye master screen image and a left eye master screen image;
a first image position adjustment section configured to adjust a display position of the right eye slave screen image such that the right eye slave screen image shifts left by a predetermined amount and to adjust a display position of the left eye slave screen image such that the left eye slave screen image shifts right by a predetermined amount;
an image combination section configured to combine the right eye slave screen image that has been adjusted and the right eye master screen image to generate a right eye image and to combine the left eye slave screen image that has been adjusted and the left eye master screen image to generate a left eye image; and
a display section configured to display stereoscopic video by using the right eye image and the left eye image.

2. The stereoscopic display apparatus according to claim 1, further comprising a second image position adjustment section configured to adjust a display position of the right eye master screen image such that the right eye master screen image shifts right by a predetermined amount and to adjust a display position of the left eye master screen image such that the left eye master screen image shifts left by a predetermined amount, wherein
the image combination section combines the right eye slave screen image that has been adjusted and the right eye master screen image that has been adjusted, to generate a right eye image, and combines the left eye slave screen image that has been adjusted and the left eye master screen image that has been adjusted, to generate a left eye image.

3. The stereoscopic display apparatus according to claim 1, further comprising an image processing section configured to correct an image contour of the slave screen to be sharp and to correct an image contour of the master screen to be soft.

4. The stereoscopic display apparatus according to claim 2, further comprising an image processing section configured to correct an image contour of the slave screen to be sharp and to correct an image contour of the master screen to be soft.

5. The stereoscopic display apparatus according to claim 1, further comprising an image processing section configured to increase an image brightness of the slave screen and to decrease an image brightness of the master screen.

6. The stereoscopic display apparatus according to claim 2, further comprising an image processing section configured to increase an image brightness of the slave screen and to decrease an image brightness of the master screen.

7. The stereoscopic display apparatus according to claim 1, further comprising an image size adjustment section configured to enlarge or reduce an image size of the slave screen.

8. The stereoscopic display apparatus according to claim 2, further comprising an image size adjustment section configured to enlarge or reduce an image size of the slave screen.

9. A stereoscopic display method capable of superimposing and displaying two images, the stereoscopic display method comprising:
a first separation step of receiving an image signal of a slave screen and separating the image signal of the slave screen into a right eye slave screen image and a left eye slave screen image;
a second separation step of receiving an image signal of a master screen and separating the image signal of the master screen into a right eye master screen image and a left eye master screen image;
a first adjustment step of adjusting a display position of the right eye slave screen image such that the right eye slave screen image shifts left by a predetermined amount and adjusting a display position of the left eye slave screen image such that the left eye slave screen image shifts right by a predetermined amount;
a first generation step of combining the right eye slave screen image that has been adjusted and the right eye master screen image to generate a right eye image;
a second generation step of combining the left eye slave screen image that has been adjusted and the left eye master screen image to generate a left eye image; and
a step of displaying stereoscopic video by using the right eye image and the left eye image.

10. The stereoscopic display method according to claim 9, further comprising a second adjustment step of adjusting a display position of the right eye master screen image such that the right eye master screen image shifts right by a predetermined amount and adjusting a display position of the left eye master screen image such that the left eye master screen image shifts left by a predetermined amount, wherein
the first generation step combines the right eye slave screen image that has been adjusted and the right eye master screen image that has been adjusted, to generate a right eye image, and
the second generation step combines the left eye slave screen image that has been adjusted and the left eye master screen image that has been adjusted, to generate a left eye image.

11. The stereoscopic display method according to claim 9, further comprising a step of correcting an image contour of the slave screen to be sharp and correcting an image contour of the master screen to be soft.

12. The stereoscopic display method according to claim 10, further comprising a step of correcting an image contour of the slave screen to be sharp and correcting an image contour of the master screen to be soft.

13. The stereoscopic display method according to claim 9, further comprising a step of increasing an image brightness of the slave screen and decreasing an image brightness of the master screen.

14. The stereoscopic display method according to claim 10, further comprising a step of increasing an image brightness of the slave screen and decreasing an image brightness of the master screen.

15. The stereoscopic display method according to claim 9, further comprising a step of enlarging or reducing an image size of the slave screen.

16. The stereoscopic display method according to claim 10, further comprising a step of enlarging or reducing an image size of the slave screen.
